(19) United States
(12) Patent Application Publication
(10) Pub. No.: US 2026/0033673 A1
(43) Pub. Date: Feb. 5, 2026

(54) Multifeatured Cutting Board

(71) Applicant: Ricky Rice, Ft Lauderdale, FL (US)

(72) Inventor: Ricky Rice, Ft Lauderdale, FL (US)

(21) Appl. No.: 18/788,488

(22) Filed: Jul. 30, 2024

(51) Int. Cl. A47J 47/00

(52) U.S. Cl. CPC A47J 47/005

(57) ABSTRACT

A multifeatured cutting board capable of easily being cleaned and stored while providing additional functionality is desired. The first surface includes a smooth face. The second surface includes a plurality of elongated parallel ridges. In one orientation, the smooth face provides a smooth support surface for cutting a food item. In an opposite orientation, the ridges support food items in a way that enhances airflow, allowing frozen food items to thaw more quickly. The planar body further includes an integrated knife holder. The perimeter shape of the planar body includes various ornamental or functional designs and shapes.

### BACKGROUND OF THE INVENTION

Many individuals use cutting boards when preparing food at home, however many traditional cutting boards may lack a desired aesthetic appeal. Additionally, many typical cutting boards merely provide a surface on which to cut items without providing any further functionality. Individuals may find it difficult to store a knife in proximity to the cutting board. Furthermore, cutting boards may be difficult to clean and store after use.

Therefore, a multifeatured cutting board capable of easily being cleaned and stored while providing additional functionality is desired.

### SUMMARY OF THE INVENTION

In view of the foregoing disadvantages inherent in the known types of cutting boards now present in the known art, the present invention provides a multifeatured cutting board wherein the same can be utilized for providing convenience for the user when preparing food items.

The present system comprises a multifeatured cutting board, comprising a planar body having a first surface and an opposing second surface, wherein the first surface provides a smooth support surface adapted for cutting a food item, and wherein the second surface provides a plurality of elongated parallel ridges.

It is an object of the present invention to provide a multifeatured cutting board that includes an integrated knife.

It is an object of the present invention to provide a multifeatured cutting board that includes a plurality of thawing strips disposed on a back facing of the multifeatured cutting board.

It is an object of the present invention to provide a multifeatured cutting board that includes a convenient hang hole.

It is an object of the present invention to provide a multifeatured cutting board that includes an anti-microbial surfacing disposed on a back facing of the multifeatured cutting board.

It is an object of the present invention to provide a multifeatured cutting board that is used for Kosher food preparation.

### BRIEF DESCRIPTION OF DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a first surface of an embodiment of a multifeatured cutting board.

FIG. 2 shows a perspective view of an embodiment of the multifeatured cutting board with an integrated knife.

FIG. 3 shows a perspective view of the second surface of an embodiment of the multifeatured cutting board.

### DETAILED DESCRIPTION OF THE INVENTION

Reference is made herein to the attached drawings. Like reference numerals are used throughout the drawings to depict like or similar elements of the multifeatured cutting board. The figures are intended for representative purposes only and should not be considered to be limiting in any respect.

The below disclosed subject matter is to be considered illustrative, and not restrictive, and any appended claim(s) are intended to cover all such modifications, enhancements, and other embodiment(s) which fall within the true scope of the non-limiting exemplary embodiment(s). Thus, to the maximum extent allowed by law, the scope of the non-limiting exemplary embodiment(s) is to be determined by the broadest permissible interpretation of the claim(s) and their equivalents, and shall not be restricted or limited by the foregoing detailed description.

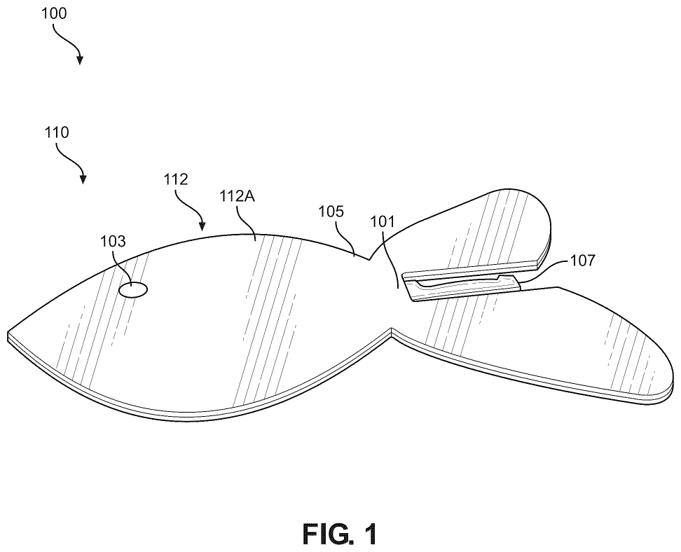

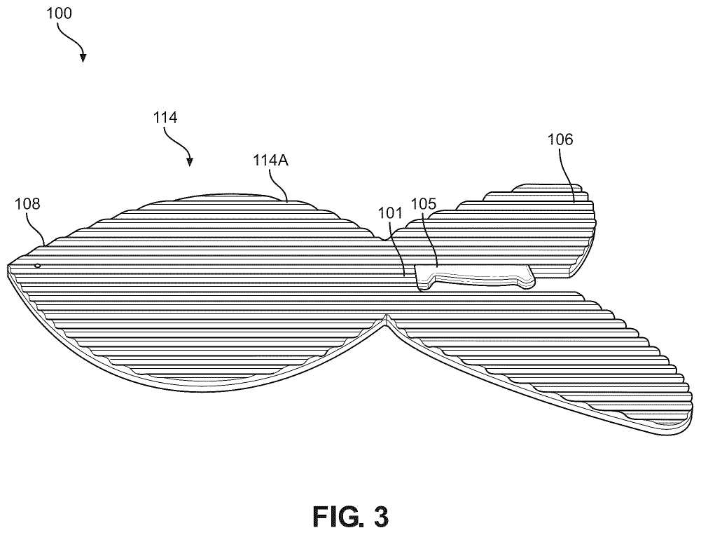

Referring now to FIGS. 1 and 3, there is shown a perspective view of a first surface 112 of an embodiment of the multifeatured cutting board 100 and a perspective view of a second surface 114 of an embodiment of the multifeatured cutting board 100, respectively.

The multifeatured cutting board 100 may include a planar body 110 having a first surface 112 and an opposing second surface 114. In the illustrated embodiment, the planar body 110 comprises a perimeter shape of a fish 105 or the like, wherein a pair of rear fins 106 extend from one side of the planar body 110, and the planar body 110 tapers to a rounded point 108 on an opposite side of the planar body 110.

The first surface 112 may include a smooth facing 112A or the like. The second surface 114 may include a plurality of elongated parallel ridges 114A or the like. In one orientation, the first surface 112 provides a smooth support surface 112A for cutting a food item. In an opposite orientation, the elongated parallel ridges 114A support food items in a way that enhances airflow, allowing frozen food items to thaw more quickly. In some embodiments, the elongated parallel ridges 114A are made of a material with a high heat transfer coefficient, thereby ensuring that heat is more rapidly transferred into the food item during the thawing process.

The planar body 110 may further include an integrated knife holder 101. In the shown embodiment, the integrated knife holder 101 is disposed between the pair of rear fins 106, such that a handle of an integrated knife 107 is disposed entirely within a perimeter of the planar body 110. In the shown embodiment, a convenient hang hole 103 is disposed through the planar body 110, wherein the convenient hang hole 103 is configured to receive a support therethrough, thereby allowing a user to hang the multifeatured cutting board 100 from a wall surface. In some embodiments, the convenient hang hole 103 is disposed in a position to replicate a desired aesthetic appearance, such as in a position representing an eye of a fish or the like. The perimeter shape of the planar body 110 may include various ornamental or functional designs and shapes.

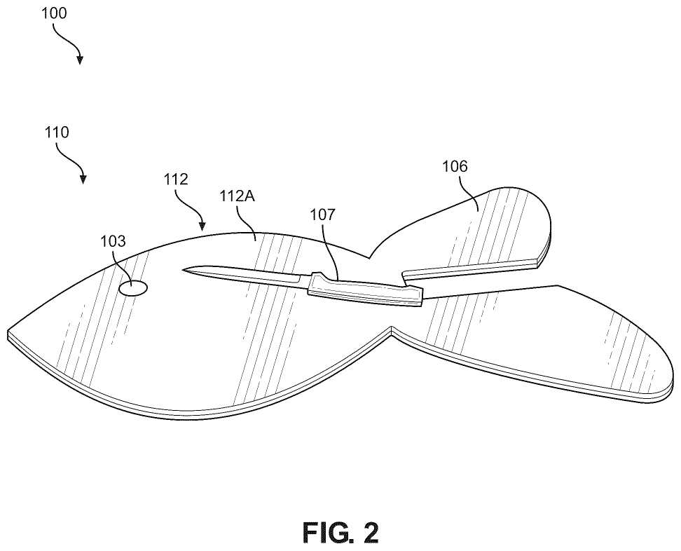

Referring now to FIG. 2, there is shown a perspective view of an embodiment of the multifeatured cutting board 100 with an integrated knife 107. In one use, the user may place the planar body 110 such that the first surface 112 is exposed. A food item may be placed on the first surface 112 and then cut in a desired manner using the integrated knife 107 stored within the integral knife holder 101. Alternatively, the user may place the planar body 110 on a surface such that the second surface 114 may be exposed, wherein a frozen food item may be placed thereon. When air flows between the elongated parallel ridges 114A, the food item may be thawed more quickly than on a flat surface. When the user is finished using the multifeatured cutting board 100, the multifeatured cutting board 100 may be quickly and easily cleaned and stored by placing a support through the convenient hang hole 103 in the multifeatured cutting board 100, minimizing the storage space required. In this manner, the multifeatured cutting board 100 makes preparing food easier and more efficient by providing cutting and thawing surfaces in a single item.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A multifeatured cutting board, comprising:
a planar body having a first surface and an opposing second surface;
wherein the first surface provides a smooth support surface adapted for cutting a food item; and
wherein the second surface provides a plurality of elongated parallel ridges.

2. The multifeatured cutting board, according to claim 1, wherein the planar body is designed for Kosher food preparation.

3. The multifeatured cutting board, according to claim 1, wherein the planar body includes an integrated knife holder.

4. The multifeatured cutting board, according to claim 3, wherein the planar body includes an integrated knife contained in the integrated knife holder.

5. The multifeatured cutting board, according to claim 1, wherein the planar body includes a convenient hang hole.

6. The multifeatured cutting board, according to claim 1, wherein the planar body is Fish-shaped.

7. The multifeatured cutting board, according to claim 1, wherein the second surface is an anti-microbial surfacing.

8. The multifeatured cutting board, according to claim 1, wherein the elongated parallel ridges enhances airflow that are adapted to facilitate one or more frozen food items to thaw.

9. The multifeatured cutting board, according to claim 1, wherein the elongated parallel ridges are made of a material with a high heat transfer coefficient.

10. The multifeatured cutting board, according to claim 1, wherein the elongated parallel ridges ensures that heat is transferred into the one or more frozen food items during the thawing process.
